(19) United States
(12) Patent Application Publication
(10) Pub. No.: US 2018/0317468 A1
(43) Pub. Date: Nov. 8, 2018

(54) FISHING LURE AND PACKAGING METHOD

(71) Applicant: Robert R. Rauch, Chanhassen, MN (US)

(72) Inventor: Robert R. Rauch, Chanhassen, MN (US)

(21) Appl. No.: 15/899,371

(22) Filed: Feb. 20, 2018

Related U.S. Application Data
(60) Provisional application No. 62/460,110, filed on Feb. 17, 2017.

(51) Int. Cl. A01K 85/01; A01K 85/00; A01K 97/04

(52) U.S. Cl. CPC A01K 85/01; B65D 33/2508; A01K 97/04; A01K 85/005

(57) ABSTRACT

At least one lure resembling, for example, a worm or other live bait (crawfish, frog, etc.), is packaged in a closed container which contains coffee grounds or other scent and/or flavor imparting particulate material in contact therewith.

### CROSS REFERENCE TO RELATED APPLICATIONS

This application claims the benefit of U.S. Provisional Application No. 62/460,110 filed Feb. 17, 2017 entitled SOFT PLASTIC FISHING LURE AND PACKAGING METHOD.

### BACKGROUND OF THE INVENTION

The present invention relates to a fishing lure, and more particularly, a lure advantageously comprising a soft plastic, for example taking the shape of a worm, and a packaging method for the lure which improves the effectiveness of the lure in attracting fish strikes and which enhances sales appeal to consumers.

Soft plastic worms are a popular replacement for live bait, and are used regularly by anglers, particularly bass fisherman. It is understood by anglers that fish can detect oils and human scent on these lures after they have been handled, and such residue will potentially adversely affect a frequency of fish strikes.

Some have suggested the use of coffee and coffee derivatives in masking human scent. Others believe that fish are actually drawn to the aroma of coffee and/or the caffeine contained therein.

Soft plastic lures are presently available in which the body of the lure is integrally molded with coffee grounds and/or coffee oils impregnated therein. This approach is discussed, for example, in published application, U.S. Pub. No. US 2008/0263933 A1, in which it is suggested that a coffee material is incorporated in, and/or deposited on an exterior surface of, a plastic body comprising a structure of a lure.

However, because the soft plastic material comprising the lure is generally somewhat transparent or translucent, if grounds internal of the plastic are used, the visibility of the grounds can alter a natural appearance of the lure, potentially alerting a fish to the fact that it is not real food. Furthermore, if a coffee material is alternatively deposited on a surface of the lure, after fishing with such lure, subsequent use of the lure will not have the desired effect of masking human scent or enhancing fish strikes.

It would therefore be desirable to have a worm or other lure optionally and advantageously comprising a soft plastic body or body portion, to which could be imparted a scent, for example, of coffee, without affecting the visual integrity of the lure, and which would allow repeated use of the lure without depletion of the imparted scent.

### SUMMARY OF THE INVENTION

It is an object of the invention to provide a lure optionally comprising a soft plastic and advantageously resembling or mimicking, for example, a worm or other live bait (crawfish, frog, etc.), and which is packaged in a container which contains coffee grounds and/or other scent imparting granular, particulate or powdered material (referred to herein generically as “particulate material,” “granulated material” or “particulate”), such as, for example, cocoa, in an amount which is not only sufficient to coat, or partially adhere to, the surface of the lure, but which is present in an additional surplus amount such that when the lure is returned to the container, the lure is re-exposed to the scent-imparting particulate for re-coating in advance of subsequent use.

It is a further object to increase marketability by presenting the lures, particularly those resembling worms, in a transparent package, for example, conveniently a poly bag with a header, or other type transparent bag or pouch, such that the coffee grounds or other particulate material(s) impart a familiar appearance, which mimics worms in garden soil, for greater appeal to a consumer.

Broadly stated, a package, optionally containing one or more lures advantageously including a soft plastic lure body, additionally contains a scent and/or flavor imparting granulated material (grounds or other particulate material) included with the one or more lures. The term “soft” as used herein is defined as a quality of compressibility and flexibility. As noted above, a simple poly bag containing one or a plurality of worms (or other artificial bait types) with a suitable amount of grounds or other particulates added as comprising a surrounding contact environment for the lure or lures, can suitably be used to comprise the container.

In accordance with an embodiment of the invention, the package containing one or more lures comprises a transparent bag or pouch which is advantageously re-sealable with a zip locking closure feature, in which is contained a surplus amount of scent imparting granules (particles, grounds, powder and the like), such that previously used lures can be returned for storage before future use, nestled among the grounds remaining therein for re-coating.

The soft plastics used to optionally produce at least a portion or portions of the lures are well known and comprise, for example, polyvinyl chloride (PVC), polyvinyl alcohol (PVOH), and any other suitable, advantageously flexible, plastic encountered in the industry, presently or in the future. At least a portion of the lure will advantageously have a sticky surface quality, as this will cause some of the coffee grounds or other particulates to adhere to the worm lures or other artificial bait, imparting an even more appealing visual impression of worms in soil to a consumer, and enhancing the desired utility in attracting fish and enticing them to strike the lure.

The above, and other objects, features and advantages of the present invention will become apparent from the following description read in conjunction with the accompanying drawing.

### BRIEF DESCRIPTION OF THE DRAWING

FIG. 1 is photograph of a package of lure bodies and coffee grounds, conveniently in a form of a poly bag and header; and

FIG. 2 is a front elevational depiction showing a resealable transparent pouch containing lures, conveniently in the form of simulated worms, and a quantity of granulated scent-masking or imparting material.

### DETAILED DESCRIPTION OF THE PREFERRED EMBODIMENT

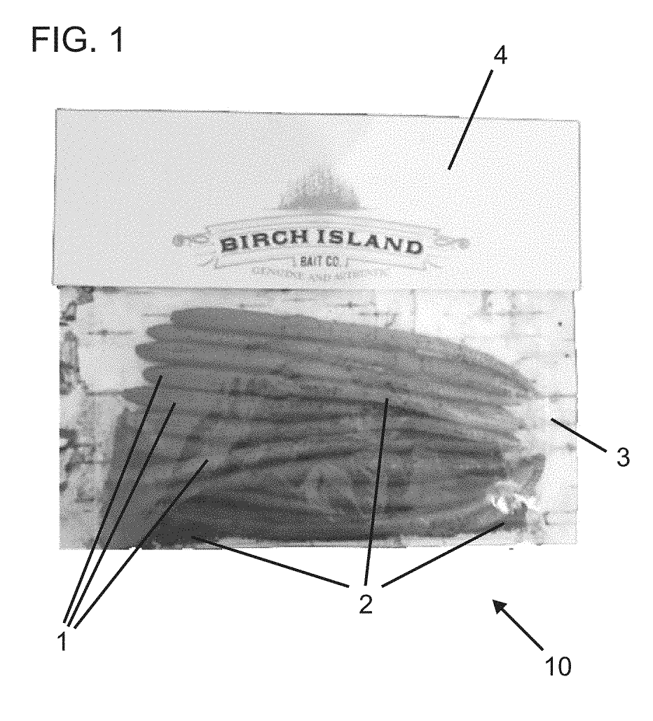

Referring to FIG. 1, an embodiment depicted includes a lure package, generally identified by reference numeral 10. Lure package 10 includes a plurality of soft plastic worms 1 (or alternatively other lure types, such a lizards, frogs, etc), an amount of coffee grounds 2 (some present as residual grounds at the bottom of the package as well as some of the grounds adhering to the worms 1) being contained conveniently in a poly bag 3, with a header 4 keeping poly bag sealed until use, and containing UPC codes and company and product information.

When displayed for purchase by a consumer, the appearance of the package 10 gives the visual impression of real worms in garden soil, and will enhance the commercial appeal of the product by subliminally attracting anglers to the very familiar, perhaps nostalgic, worm-in-soil environment.

By being stored with coffee grounds 2, in addition to being at least partially coated by a portion of the grounds 2, particularly when having a sticky surface, worms 1 will absorb the coffee essence (aroma and essential oils thereof), and when worms 1 are removed from package 10 for use, and handled, the coffee smell will mask human intervention from fish, such as, for example, bass.

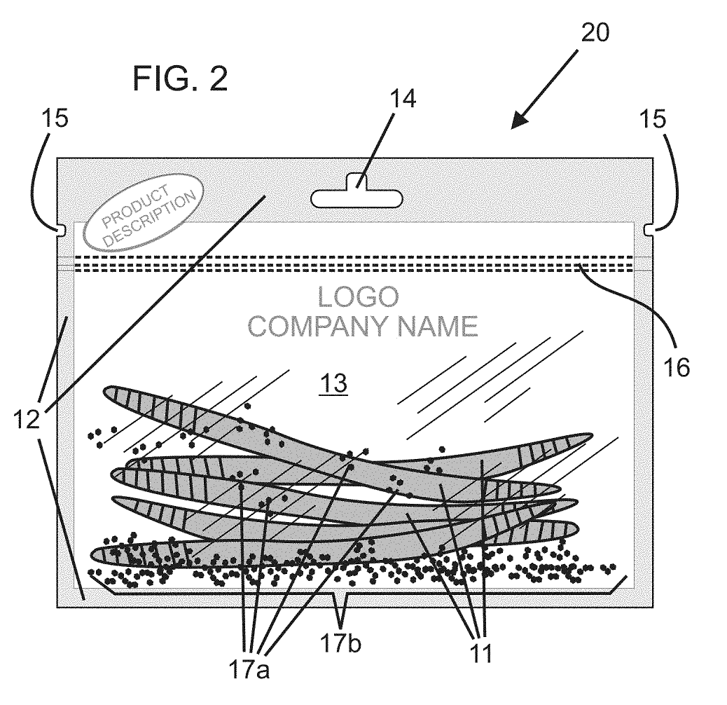

Turning now to FIG. 2, a lure kit displayed in consumer packaging is shown generally at 20. Lure kit 20 includes at least one lure 11 (five being depicted by convenient example, optionally in the shape of worms) contained in a transparent pouch 13 which conveniently includes printing applied to a surface thereof, such as product description, logo, company name (as shown schematically thereon), leaving at least one transparent region where the pouch 13 is not printed through which the at least one lure 11 can be viewed from an exterior of the pouch 13.

An enclosed interior of pouch 13 is conveniently formed by a heat seal 12 along a perimeter thereof, according to conventional practice. Pouch 13 conveniently includes a hanger hole 14 to allow pouch to be peg mounted for display. A pair of indents 15 are optionally formed at top sides of pouch 13 to facilitate tearing across in order to open the pouch 13. Suitable closure structure for re-sealing pouch 13 is advantageously provided, for example, in the form of a zip locking type closure structure 16. Other forms of closure allowing reopening may be alternatively provided without departure from the invention.

As shown in FIG. 2, the interior of the pouch contains, by example, five lures 11 (in the form of simulated worms) and an amount of scent imparting particulate material comprised of a coating portion of particulate material 17a that adheres to a surface of the lures 11 and a residual portion (surplus portion) of particulate material 17b that accumulates at the bottom interior of the pouch 13. As such, in practice of a method embodiment according to the invention, after a lure 11 is removed from pouch 13 and used in the course of fishing, it can be returned to the pouch 13, which is then sealed by closure structure 16, and re-coated with a new coating portion of particulate material 17a when brought into contact with the residual portion of particulate material 17b remaining at the bottom interior of pouch 13.

It is noted that the lures in accordance with the invention can be provided without hooks (as shown in the depicted examples), or with hooks, without departure from the invention.

It is also contemplated that the particulate material embraced within the contemplated scope of the invention need not be limited to coffee grounds or ground cocoa powder, and broadly includes any scent and or flavor imparting material comprising discrete particles, granules, powderized substances either derived from ground natural material, such as coffee beans or parts derived from other plant sources, as well as artificially produced particles which contain a scent and or flavor component. For example, a rubber composition or other material infused with essential oil or other source of fragrance which is ground into discrete particles is deemed to be within the scope of the invention.

Further, the container in which the lure(s) are held need not be a bag or pouch, but could also comprise a box, tin, can or any other container suited to meeting the objectives broadly expressed above herein.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

What is claimed is:

1. A lure kit, comprising:
at least one lure including a lure body or body portion;
a container in which said at least one lure is received; and
a particulate material capable of imparting at least one of scent or flavor being contained within said container along with the at least one lure, and in contact therewith, comprising an amount sufficient to adhere to a surface of the at least one lure and an additional amount serving as a surrounding environment within said container in which the at least one lure rests.

2. A lure kit according to claim 1, wherein said particulate material includes coffee grounds.

3. A lure kit according to claim 1, wherein said particulate material includes cocoa.

4. A lure kit according to claim 1, wherein said particulate material resembles garden soil.

5. A lure kit according to claim 1, wherein said at least one lure resembles a worm.

6. A lure kit according to claim 1, wherein said container includes a resealable bag including at least one transparent region through which said at least one lure can be viewed from an exterior of the container.

7. A lure kit according to claim 1, wherein said lure body or said body portion comprises a soft plastic.

8. A method of marketing a lure to a consumer, comprising:
enclosing at least one fishing lure in a package, said package including at least one transparent region through which said at least one fishing lure can be viewed from an exterior of the package;
adding a particulate material capable of imparting at least one of scent or flavor to said package along with the lures, and in contact therewith, to form a consumer sales unit; and
displaying said sales unit for viewing and potential purchase by the consumer.

9. A method according to claim 8, wherein said transparent package includes a resealable bag.

10. A method according to claim 8, wherein said particulate material includes coffee grounds.

11. A method according to claim 8, wherein said transparent package is peg mountable for said displaying.

12. A method according to claim 8, further comprising:
instructing the consumer to replace the at least one lure to the package after use to be re-coated with the particulate material.

13. A method of enhancing lure performance, comprising:
providing a resealable container;
adding a particulate material capable of imparting at least one of scent or flavor to an interior of said container; and
placing at least one lure into said interior along with said particulate material such that a portion of said particulate material at least partially adheres to a surface of the at least one lure, and a remaining portion of said particulate material serves as a local environment for said at least one lure.

14. A method according to claim 13, wherein said at least one lure comprises a soft plastic portion.

15. A method according to claim 13, further comprising:
removing said at least one lure from said container for use in attracting fish to strike; and
returning the at least one lure, after said use, to said container such that said at least one lure is again brought into contact with the remaining portion of the particulate material.

16. A method according to claim 13, wherein said particulate material includes at least one of coffee grounds or cocoa.
